(19) United States
(12) Patent Application Publication
(10) Pub. No.: US 2026/0119460 A1
(43) Pub. Date: Apr. 30, 2026

(54) HIGH-CONCURRENCY READ/WRITE OPTIMIZATION SYSTEM FOR DISTRIBUTED FILE SYSTEM, MEDIUM, AND DEVICE

(71) Applicant: SHANGHAI JIAO TONG UNIVERSITY, Shanghai (CN)

(72) Inventors: Shengan ZHENG, Shanghai (CN); Linpeng HUANG, Shanghai (CN); Zhenlin QI, Shanghai (CN); Bowen ZHANG, Shanghai (CN); Yuting CHEN, Shanghai (CN); Yanyan SHEN, Shanghai (CN)

(73) Assignee: SHANGHAI JIAO TONG UNIVERSITY, Shanghai (CN)

(21) Appl. No.: 19/477,807

(22) PCT Filed: May 16, 2024
(86) PCT No.: PCT/CN2024/093554

§ 371 Date: Oct. 23, 2025

(30) Foreign Application Priority Data
Jun. 25, 2023 (CN) 202310755386.6

(51) Int. Cl. G06F 16/176; G06F 16/13; G06F 16/172; G06F 16/182

(52) U.S. Cl. CPC G06F 16/1774; G06F 16/172; G06F 16/182; G06F 16/137

(57) ABSTRACT

A high-concurrency read/write optimization system for a distributed file system, a medium, and a device are provided. The high-concurrency read/write optimization system includes: a data read/write concurrency control module configured to ensure consistency and high concurrency of data through a fine-grained read/write lock; a file data cache module configured to control data caching of a client system towards a server file system; a read/write request latency prediction module configured to predict a runtime latency of a file read/write request from a client to provide a path optimization scheme; and a read/write task execution module configured to ensure read/write performance under a high-concurrency condition by simultaneously executing local and remote data read/write operations. The high-concurrency read/write optimization system primarily addresses the performance bottleneck of distributed file systems constructed based on non-volatile memory (NVM) and remote direct memory access (RDMA) technologies when dealing with high-concurrency read/write tasks.

### CROSS REFERENCE TO THE RELATED APPLICATIONS

This application is the national phase entry of International Application No. PCT/CN2024/093554, filed on May 16, 2024, which is based upon and claims priority to Chinese Patent Application No. 202310755386.6, filed on Jun. 25, 2023, the entire contents of which are incorporated herein by reference.

### TECHNICAL FIELD

The present disclosure relates to the technical field of computer system architecture, and in particular to a high-concurrency read/write optimization system for a distributed file system, a medium, and a device.

### BACKGROUND

Distributed storage systems are generally used to solve the problem of insufficient storage capacity in a single computer. With the advent of networks and the big data era, single-node computer systems cannot meet the demands of scientific research fields and commercial applications. Generally, a distributed storage system runs on a distributed cluster composed of multiple nodes, where some nodes store data while some other nodes perform computation. The computation can include data input/output (IO) requests and logical functions of application programs. Determining the quality of a distributed storage system mainly involves determining whether it satisfies some basic properties of distributed systems, such as consistency, availability, and partition tolerance, as well as whether it provides high-performance data services for computing nodes in the cluster.

In recent years, some emerging hardware technologies have presented new challenges to the design of distributed storage systems. For example, non-volatile memory (NVM) and remote direct memory access (RDMA) technology enable both the design of storage systems and the design of distributed systems to break through original limitations, allowing for new optimization solutions tailored to new hardware.

As a new type of memory hardware technology, NVM or persistent memory (PM) has the following three hardware characteristics. First, it is byte-addressable and supports the processor's direct load/store instructions. Second, it has latency and bandwidth close to direct random access memory (DRAM). Third, it is non-volatile and does not lose stored data upon power failure. These excellent hardware characteristics enable NVM to be used as a new storage hierarchy between memory and disk or to directly replace memory and disk to form a single-level storage system.

RDMA technology enables direct mutual memory access between different computers in a cluster. Here, the meaning of “direct” is to read and modify the remote memory without notifying the remote central processing unit (CPU). From the perspective of in-memory computing, RDMA technology shares a similar starting point with direct memory access (DMA) in a single-node computer, that is, to reduce the burden on the CPU for memory-related requests, thereby improving overall system performance. Additionally, from the perspective of network connectivity, RDMA technology is a new generation of network communication technology, offering lower communication latency and higher cross-node data throughput compared to traditional server clusters connected via Ethernet.

Therefore, a new technical solution is required to solve the above technical problems.

### SUMMARY

To address defects in the prior art, an objective of the present disclosure is to provide a high-concurrency read/write optimization system for a distributed file system, a medium, and a device.

The high-concurrency read/write optimization system for a distributed file system provided by the present disclosure includes following modules:

a module M1, specifically, a data read/write concurrency control module, configured to acquire consistent and highly concurrent data through a fine-grained read/write lock;

a module M2, specifically, a file data cache module, configured to control data caching of a server file system by a client system;

a module M3, specifically, a read/write request latency prediction module, configured to predict a runtime latency of a file read/write request in a file system client; and

a module M4, specifically, a read/write task execution module, configured to acquire read/write performance under a concurrent condition by simultaneously executing local and remote data read/write operations;

where, the data read/write concurrency control module processes multi-thread concurrent file data read/write requests from multiple clients and acquires consistent file data and concurrent read/write requests;

the file data cache module constructs a file data cache in the client system, such that a recent read/write request to a file by an application is stored in a local data cache;

the read/write latency prediction module records a latency of a data read/write task in the system and predicts a runtime read/write request latency through a prediction model; and

the read/write task execution module maintains two thread pools, executes a data read/write task on a remote server and a data read/write task on a local cache, respectively, and acquires the read/write performance under the concurrent condition.

Preferably, the module M1 includes:

a module M1.1, specifically, a binary tree-based fine-grained file data read/write lock module; and

a module M1.2, specifically, a hash table-based client data permission lease module;

where, the fine-grained file data read/write lock module includes a binary tree list; each binary tree in the list corresponds to a file data read/write lock management unit in an open state; and the binary tree list uses a unique identifier of the file in the distributed file system as an index;

each binary tree includes a data interval occupied by a read/write request for a current file; the interval is represented by a tuple including a start offset and a length of the read/write request; a root node of the binary tree corresponds to an interval of all data in the file, and each child node corresponds to a data interval acquired by bisecting a parent node interval; and a corresponding data segment of each node includes a read/write lock, allowing a requester to simultaneously acquire one-write-multiple-read permissions;

when a new read/write request is submitted to a file server, a data read/write lock binary tree corresponding to a file number is indexed, and a read/write permission record on a corresponding node is searched for, added, or modified; and when a read/write permission is reclaimed, the read/write permission on the corresponding node is modified or deleted;

the client data permission lease module includes a hash table including a lease record, where the harsh table maintains all read/write lease permissions currently retained by the client system;

when a client application initiates a file read/write request, the read/write request is submitted to a file system server while a data caching request is submitted to the module M2; and

when processing of a read/write permission request and the caching request is completed, a read/write descriptor is added to the hash table while the read/write request to be executed is sent to the module M3.

Preferably, the module M2 includes:

a data cache management module running in the client system of the distributed file system;

where, the data cache management module includes a metadata cache unit, a data cache unit, and a metadata management unit for the local data cache;

when the client system initiates a metadata operation-related request, the metadata cache unit requests a metadata permission from the file system server and caches a relevant metadata region locally on the client; and

when the client system initiates a data read/write-related request, the data cache unit reads or writes back data from/to the file system server; and simultaneously, the metadata management unit for the local data cache modifies metadata information in a local cache region.

Preferably, the module M3 includes:

a module M3.1, specifically, a data read/write task latency recording module;

a module M3.2, specifically, a read/write latency prediction model training module; and

a module M3.3, specifically, a real-time read/write task latency prediction module;

where, when the module M4 executes a read/write task, the read/write task latency recording module is awakened and tracks a descriptive parameter and start/end time of the read/write task; and simultaneously, the module sequentially records a data structure including the descriptive parameter and start/end time of each read/write task into persistent file storage;

when a size change of a read/write task latency record file output by the module M3.1 exceeds a certain threshold, the latency prediction model training module reads a newly added task latency record in the file, and converts the newly added task latency record into empirical knowledge for the prediction model through a model training method; and

when receiving a read/write task sent by the module M1, the real-time read/write task latency prediction module inputs the received real-time read/write task into the trained latency prediction model, predicts a latency of executing the read/write task via a remote server node and a latency of executing the read/write task via the local cache and bypassing the remote node, respectively, and compares the two latencies to acquire an option for a read/write path scheme.

Preferably, the module M3.1 includes:

a module M3.1.1, specifically, a file system read/write operation tracking module; and

a module M3.1.2, specifically, a read/write latency record persistence and summarization module;

where, when the module M4 executes a remote or local read/write task, the file system read/write operation tracking module records a parameter of the read/write task, including a read/write file identifier, a read/write flag, a remote/local flag, a read/write offset, and a read/write length, and simultaneously records a start time of the read/write task;

when the module M4 completes the remote or local read/write task, the file system read/write operation tracking module records an end time of the read/write task;

when the file system read/write operation tracking module completes a task record, the read/write latency record persistence and summarization module writes the record to a persistent local file; the file is opened in append mode; and each time when new content is appended, the new content is sequentially written to the file;

when a record length of the persistent local file exceeds a threshold, the newly appended content in the file is submitted to the read/write latency prediction model training module; and

when data recorded in the persistent local file has been processed by the read/write latency prediction model training module, the read/write latency record persistence and summarization module truncates old data recorded in the local file, ensuring that a record file size does not exceed the threshold.

Preferably, the module M3.2 includes:

a module M3.2.1, specifically, a read/write latency prediction model construction module; and

a module M3.2.2, specifically, a latency prediction model training and update module;

where, when the high-concurrency read/write optimization system for a distributed file system is constructed, the read/write latency prediction model construction module constructs a neural network-based read/write latency prediction model;

the neural network-based read/write latency prediction model includes a double-layer fully connected neural network; the neural network takes the descriptive parameter of the read/write task as input data and outputs a real-time latency prediction result for the read/write task, in a real-world standard time unit;

before construction of the read/write latency prediction model is completed, neural network model parameters of the prediction model are subjected to two initialization schemes; in a first scheme, the model parameters all are initialized to zero values; and in a second scheme, the model parameters are initialized to parameters of a latency prediction model trained in another system;

when construction of the read/write latency prediction model is completed, the model is persistently stored as a file; and the file is readable and writable by the read/write latency prediction model training module and read-only for another module in the system;

when receiving a read/write task record from the read/write latency record persistence and summarization module, the latency prediction model training and update module performs a latency prediction model training and update operation;

the latency prediction model training and update module uses the input read/write task record and a corresponding real-time latency result as input and output training data for the neural network model, respectively, and trains the latency prediction model using a gradient descent method until an error between a latency prediction result of the model and actual latency data converges; and

when the error acquired from model convergence is less than an average error at the start of training, the latency prediction model training and update module performs a model update to persistently store the trained model as a new storage file and overwrite an original model storage file.

Preferably, the module M3.3 includes:

a module M3.3.1, specifically, a real-time device read/write pressure collection module; and

a module M3.3.2, specifically, a real-time read/write task latency prediction module;

where, when the real-time read/write task latency prediction module receives a real-time read/write latency prediction request, the real-time device read/write pressure collection module acquires summary information of a read/write task currently being executed in the read/write task execution module of the system and sends the information as part of a parameter to the neural network-based read/write latency prediction model;

when the real-time device read/write pressure collection module completes the collection and sending operation, the real-time read/write task latency prediction module invokes the neural network-based prediction model to perform real-time read/write latency prediction; and

when the real-time read/write latency prediction is completed, the read/write task latency prediction module submits a prediction result to the read/write task execution module.

Preferably, the module M4 includes:

a module M4.1, specifically, an RDMA-based remote data read/write thread pool module; and

a module M4.2, specifically, a NVM-based cache data read/write thread pool module;

when the high-concurrency read/write optimization system for a distributed file system is constructed, the RDMA-based remote data read/write thread pool module initializes a certain number of RDMA connections and completes an information exchange test between the client system and the server file system;

when an RDMA connection is established, the RDMA-based remote data read/write thread pool module creates an RDMA primitive-based remote data read/write thread pool and sets all threads to an idle state;

when a new remote read/write task is submitted to the read/write task execution module, the RDMA-based remote data read/write thread pool module schedules an idle thread to execute the task;

when the high-concurrency read/write optimization system for a distributed file system is constructed, the NVM-based cache data read/write thread pool module completes a read/write operation test of the client system on a local NVM;

when the read/write operation test on the NVM is completed, the NVM-based cache data read/write thread pool module creates a load/store primitive-based NVM data read/write thread pool and sets all threads to an idle state; and

when a new local read/write task is submitted to the read/write task execution module, the NVM-based cache data read/write thread pool module schedules an idle thread to execute the task.

The present disclosure further provides a computer-readable storage medium for storing a computer program, where the computer program is executed by a processor to implement functions of the modules described above.

The present disclosure further provides an electronic device, including: a memory, a processor, and a computer program stored on the memory and runnable on the processor, where the computer program is executed by the processor to implement functions of the modules described above.

Compared with the prior art, the present disclosure has the following beneficial effects:
1. The present disclosure addresses the performance bottleneck of distributed file systems for high-concurrency file read/write requests and proposes optimization methods in three directions: concurrency control, latency optimization, and concurrent execution.
2. In terms of concurrency control, the fine-grained concurrency control mechanism used in the present disclosure enables concurrent read/write requests on the same file to be executed simultaneously, breaking through the performance bottleneck of original file read/write locks and bringing significant performance improvements.
3. In terms of latency optimization, the present disclosure adopts a neural network-based multi-path latency prediction and read/write path selection scheme, with an essence to explore more hardware performance potential and make real-time optimization decisions during system runtime.
4. The present disclosure improves the overall performance of the distributed file system and is compatible with mainstream operating systems and file system interfaces, possessing good market prospects and application value.

### BRIEF DESCRIPTION OF THE DRAWINGS

Other features, objectives, and advantages of the present disclosure will become more apparent by reading the detailed description of non-limiting embodiments with reference to the following drawings.

FIG. 1 is an overall module diagram of an apparatus in an embodiment of the present disclosure;

FIG. 2 is a schematic diagram of a data read/write concurrency control module of the apparatus in an embodiment of the present disclosure;

FIG. 3 is a schematic diagram of a file data cache module of the apparatus in an embodiment of the present disclosure;

FIG. 4 is a schematic diagram of a read/write request latency prediction module of the apparatus in an embodiment of the present disclosure; and

FIG. 5 is a schematic diagram of a read/write task execution module of the apparatus in an embodiment of the present disclosure.

### DETAILED DESCRIPTION OF THE EMBODIMENTS

The present disclosure is described in detail below with reference to specific embodiments. The following embodiments will help those skilled in the art to further understand the present disclosure, without limiting the present disclosure in any way. It should be noted that several variations and improvements can also be made by a person of ordinary skill in the art without departing from the conception of the present disclosure. These all fall within the protection scope of the present disclosure.

### Embodiment 1

The present disclosure provides a high-concurrency read/write optimization system for a distributed file system. Modules of the high-concurrency read/write optimization system are described as follows.

Module M1 is specifically a data read/write concurrency control module, configured to acquire consistent and highly concurrent data through a fine-grained read/write lock.

Module M1.1 is specifically a binary tree-based fine-grained file data read/write lock module.

Module M1.2 is specifically a hash table-based client data permission lease module.

The fine-grained file data read/write lock module includes a binary tree list. Each binary tree in the list corresponds to a file data read/write lock management unit in an open state. The binary tree list uses a unique identifier of the file in the distributed file system as an index.

Each binary tree includes a data interval occupied by a read/write request for a current file. The interval is represented by a tuple including a start offset and a length of the read/write request. A root node of the binary tree corresponds to an interval of all data in the file, and each child node corresponds to a data interval acquired by bisecting a parent node interval. A corresponding data segment of each node includes a read/write lock, allowing a requester to simultaneously acquire one-write-multiple-read permissions.

When a new read/write request is submitted to a file server, a data read/write lock binary tree corresponding to a file number is indexed, and a read/write permission record on a corresponding node is searched for, added, or modified; and when a read/write permission is reclaimed, the read/write permission on the corresponding node is modified or deleted.

The client data permission lease module includes a hash table including a lease record, where the harsh table maintains all read/write lease permissions currently retained by the client system.

When a client application initiates a file read/write request, the read/write request is submitted to a file system server while a data caching request is submitted to the module M2.

When processing of a read/write permission request and the caching request is completed, a read/write descriptor is added to the hash table while the read/write request to be executed is sent to module M3.

Module M2 is specifically a file data cache module, configured to control data caching of a server file system by a client system.

The module M2 includes: a data cache management module running in the client system of the distributed file system.

The data cache management module includes a metadata cache unit, a data cache unit, and a metadata management unit for the local data cache.

When the client system initiates a metadata operation-related request, the metadata cache unit requests a metadata permission from the file system server and caches a relevant metadata region locally on the client.

When the client system initiates a data read/write-related request, the data cache unit reads or writes back data from/to the file system server. Simultaneously, the metadata management unit for the local data cache modifies metadata information in a local cache region.

Module M3 is specifically a read/write request latency prediction module, configured to predict a runtime latency of a file read/write request in a file system client.

Module M3.1 is specifically a data read/write task latency recording module.

Module M3.1.1 is specifically a file system read/write operation tracking module.

Module M3.1.2 is specifically a read/write latency record persistence and summarization module.

When the module M4 executes a remote or local read/write task, the file system read/write operation tracking module records a parameter of the read/write task, including a read/write file identifier, a read/write flag, a remote/local flag, a read/write offset, and a read/write length, and simultaneously records a start time of the read/write task.

When the module M4 completes the remote or local read/write task, the file system read/write operation tracking module records an end time of the read/write task.

When the file system read/write operation tracking module completes a task record, the read/write latency record persistence and summarization module writes the record to a persistent local file. The file is opened in append mode. Each time when new content is appended, the new content is sequentially written to the file.

When a record length of the persistent local file exceeds a threshold, the newly appended content in the file is submitted to the read/write latency prediction model training module.

When data recorded in the persistent local file has been processed by the read/write latency prediction model training module, the read/write latency record persistence and summarization module truncates old data recorded in the local file, ensuring that a record file size does not exceed the threshold.

Module M3.2 is specifically a read/write latency prediction model training module.

Module M3.2.1 is specifically a read/write latency prediction model construction module.

Module M3.2.2 is specifically a latency prediction model training and update module.

When the high-concurrency read/write optimization system for a distributed file system is constructed, the read/write latency prediction model construction module constructs a neural network-based read/write latency prediction model.

The neural network-based read/write latency prediction model includes a double-layer fully connected neural network. The neural network takes the descriptive parameter of the read/write task as input data and outputs a real-time latency prediction result for the read/write task, in a real-world standard time unit.

Before construction of the read/write latency prediction model is completed, neural network model parameters of the prediction model are subjected to two initialization schemes. in a first scheme, the model parameters all are initialized to zero values. In a second scheme, the model parameters are initialized to parameters of a latency prediction model trained in another system.

When construction of the read/write latency prediction model is completed, the model is persistently stored as a file. The file is readable and writable by the read/write latency prediction model training module and read-only for another module in the system.

When receiving a read/write task record from the read/write latency record persistence and summarization module, the latency prediction model training and update module performs a latency prediction model training and update operation.

The latency prediction model training and update module uses the input read/write task record and a corresponding real-time latency result as input and output training data for the neural network model, respectively, and trains the latency prediction model using a gradient descent method until an error between a latency prediction result of the model and actual latency data converges.

When the error acquired from model convergence is less than an average error at the start of training, the latency prediction model training and update module performs a model update to persistently store the trained model as a new storage file and overwrite an original model storage file.

Module M3.3 is specifically a real-time read/write task latency prediction module.

Module M3.3.1 is specifically a real-time device read/write pressure collection module.

Module M3.3.2 is specifically a real-time read/write task latency prediction module.

When the real-time read/write task latency prediction module receives a real-time read/write latency prediction request, the real-time device read/write pressure collection module acquires summary information of a read/write task currently being executed in the read/write task execution module of the system and sends the information as part of a parameter to the neural network-based read/write latency prediction model.

When the real-time device read/write pressure collection module completes the collection and sending operation, the real-time read/write task latency prediction module invokes the neural network-based prediction model to perform real-time read/write latency prediction.

When the real-time read/write latency prediction is completed, the read/write task latency prediction module submits a prediction result to the read/write task execution module.

When the module M4 executes a read/write task, the read/write task latency recording module is awakened and tracks a descriptive parameter and start/end time of the read/write task. Simultaneously, the module sequentially records a data structure including the descriptive parameter and start/end time of each read/write task into persistent file storage.

When a size change of a read/write task latency record file output by the module M3.1 exceeds a certain threshold, the latency prediction model training module reads a newly added task latency record in the file, and converts the newly added task latency record into empirical knowledge for the prediction model through a model training method.

When receiving a read/write task sent by the module M1, the real-time read/write task latency prediction module inputs the received real-time read/write task into the trained latency prediction model, predicts a latency of executing the read/write task via a remote server node and a latency of executing the read/write task via the local cache and bypassing the remote node, respectively, and compares the two latencies to acquire an option for a read/write path scheme.

Module M4 is specifically a read/write task execution module, configured to acquire read/write performance under a concurrent condition by simultaneously executing local and remote data read/write operations.

Module M4.1 is specifically an RDMA-based remote data read/write thread pool module.

Module M4.2 is specifically a NVM-based cache data read/write thread pool module.

When the high-concurrency read/write optimization system for a distributed file system is constructed, the RDMA-based remote data read/write thread pool module initializes a certain number of RDMA connections and completes an information exchange test between the client system and the server file system.

When an RDMA connection is established, the RDMA-based remote data read/write thread pool module creates an RDMA primitive-based remote data read/write thread pool and sets all threads to an idle state.

When a new remote read/write task is submitted to the read/write task execution module, the RDMA-based remote data read/write thread pool module schedules an idle thread to execute the task.

When the high-concurrency read/write optimization system for a distributed file system is constructed, the NVM-based cache data read/write thread pool module completes a read/write operation test of the client system on a local NVM.

When the read/write operation test on the NVM is completed, the NVM-based cache data read/write thread pool module creates a load/store primitive-based NVM data read/write thread pool and sets all threads to an idle state.

When a new local read/write task is submitted to the read/write task execution module, the NVM-based cache data read/write thread pool module schedules an idle thread to execute the task.

The data read/write concurrency control module processes multi-thread concurrent file data read/write requests from multiple clients and acquires consistent file data and concurrent read/write requests.

The file data cache module constructs a file data cache in the client system, such that a recent read/write request to a file by an application is stored in a local data cache.

The read/write latency prediction module records a latency of a data read/write task in the system and predicts a runtime read/write request latency through a prediction model.

The read/write task execution module maintains two thread pools, executes a data read/write task on a remote server and a data read/write task on a local cache, respectively, and acquires the read/write performance under the concurrent condition.

The present disclosure further provides a computer-readable storage medium for storing a computer program, where the computer program is executed by a processor to implement functions of the modules described above.

The present disclosure further provides an electronic device, including: a memory, a processor, and a computer program stored on the memory and runnable on the processor, where the computer program is executed by the processor to implement functions of the modules described above.

### Embodiment 2

To address defects in the prior art, an objective of the present disclosure is to provide a high-concurrency read/write optimization method and system for a distributed file system.

The high-concurrency read/write optimization method and system for a distributed file system provided by the present disclosure involve modules M1, M2, M3, and M4.

The module M1 is specifically a data read/write concurrency control module, which is configured to ensure consistency and high concurrency of data through a fine-grained read/write lock.

The module M2 is specifically a file data cache module, which is configured to control data caching of a server file system by a client system.

The module M3 is specifically a read/write request latency prediction module, which is configured to predict a runtime latency of a file read/write request in a file system client.

The module M4 is specifically a read/write task execution module, which is configured to ensure optimal read/write performance under a concurrent condition by simultaneously executing local and remote data read/write operations.

The data read/write concurrency control module processes multi-thread concurrent file data read/write requests from multiple clients and ensures consistent file data and concurrent read/write requests.

The file data cache module constructs a file data cache in the client system, such that a recent read/write request to a file by an application is stored in a local data cache.

The read/write latency prediction module records a latency of a data read/write task in the system and predicts a runtime read/write request latency through a prediction model.

The read/write task execution module maintains two thread pools, executes a data read/write task on a remote server and a data read/write task on a local cache, respectively, and ensures the optimal read/write performance under the concurrent condition.

Preferably, components of the module M1 are described as follows.

Module M1.1 is specifically a binary tree-based fine-grained file data read/write lock module.

The fine-grained file data read/write lock module includes a binary tree list; each binary tree in the list corresponds to a file data read/write lock management unit in an open state. The binary tree list uses a unique identifier of the file in the distributed file system as an index.

Each binary tree includes a data interval occupied by a read/write request for a current file. The interval is represented by a tuple including a start offset and a length of the read/write request. A root node of the binary tree corresponds to an interval of all data in the file, and each child node corresponds to a data interval acquired by bisecting a parent node interval. A corresponding data segment of each node includes a read/write lock, allowing a requester to simultaneously acquire one-write-multiple-read permissions.

When a new read/write request is submitted to a file server, a data read/write lock binary tree corresponding to a file number is indexed, and a read/write permission record on a corresponding node is searched for, added, or modified. When a read/write permission is reclaimed, the read/write permission on the corresponding node is modified or deleted.

Module M1.2 is specifically a hash table-based client data permission lease module.

The client data permission lease module includes a hash table including a lease record, where the harsh table maintains all read/write lease permissions currently retained by the client system.

When a client application initiates a file read/write request, the read/write request is submitted to a file system server while a data caching request is submitted to the module M2 according to claim 1.

When processing of a read/write permission request and the caching request is completed, a read/write descriptor is added to the hash table while the read/write request to be executed is sent to the module M3 according to claim 1.

Preferably, components of the module M2 are described as follows.

A data cache management module runs in the client system of the distributed file system.

The data cache management module includes a metadata cache unit, a data cache unit, and a metadata management unit for the local data cache.

When the client system initiates a metadata operation-related request, the metadata cache unit requests a metadata permission from the file system server and caches a relevant metadata region locally on the client.

When the client system initiates a data read/write-related request, the data cache unit reads or writes back data from/to the file system server. Simultaneously, the metadata management unit for the local data cache modifies metadata information in a local cache region. The design ensures the consistency, correctness, and integrity of the data cache region.

Preferably, components of the module M3 are described as follows.

Module M3.1 is specifically a data read/write task latency recording module.

When the module M4 according to claim 1 executes a read/write task, the read/write task latency recording module is awakened and tracks a descriptive parameter and start/end time of the read/write task. Simultaneously, the module sequentially records a data structure including the descriptive parameter and start/end time of each read/write task into persistent file storage.

Module M3.2 is specifically a read/write latency prediction model training module.

When a size change of a read/write task latency record file output by the module M3.1 according to claim 4 exceeds a certain threshold, the latency prediction model training module reads a newly added task latency record in the file, and converts the newly added task latency record into empirical knowledge for the prediction model through a model training method.

Module M3.3 is specifically a real-time read/write task latency prediction module.

When receiving a read/write task sent by the module M1 according to claim 1, the real-time read/write task latency prediction module inputs the received real-time read/write task into the trained latency prediction model, predicts a latency of executing the read/write task via a remote server node and a latency of executing the read/write task via the local cache and bypassing the remote node, respectively, and compares the two latencies to acquire an option for a read/write path optimization scheme.

Preferably, components of the module M3.1 are described as follows.

Module M3.1.1 is specifically a file system read/write operation tracking module.

When the module M4 according to claim 4 executes a remote or local read/write task, the file system read/write operation tracking module records a parameter of the read/write task, including a read/write file identifier, a read/write flag, a remote/local flag, a read/write offset, and a read/write length, and simultaneously records a start time of the read/write task.

When the module M4 according to claim 4 completes the remote or local read/write task, the file system read/write operation tracking module records an end time of the read/write task.

Module M3.1.2 is specifically a read/write latency record persistence and summarization module.

When the file system read/write operation tracking module according to claim 5 completes a task record, the read/write latency record persistence and summarization module writes the record to a persistent local file. The file is opened in append mode. each time when new content is appended, the new content is sequentially written to the file.

When a record length of the persistent local file exceeds a threshold, the newly appended content in the file is submitted to the read/write latency prediction model training module according to claim 4.

When data recorded in the persistent local file has been processed by the read/write latency prediction model training module according to claim 4, the read/write latency record persistence and summarization module truncates old data recorded in the local file, ensuring a ensure record file size does not exceed a threshold.

Preferably, components of the module M3.2 are described as follows.

Module M3.2.1 is specifically a read/write latency prediction model construction module.

When the high-concurrency read/write optimization system for a distributed file system according to claim 1 is constructed, the read/write latency prediction model construction module constructs a neural network-based read/write latency prediction model.

The neural network-based read/write latency prediction model includes a double-layer fully connected neural network. The neural network takes the descriptive parameter of the read/write task as input data and outputs a real-time latency prediction result for the read/write task, in a real-world standard time unit.

Before construction of the read/write latency prediction model is completed, neural network model parameters of the prediction model are subjected to two initialization schemes. in a first scheme, the model parameters all are initialized to zero values. In a second scheme, the model parameters are initialized to parameters of a latency prediction model trained in another system.

When construction of the read/write latency prediction model is completed, the model is persistently stored as a file. The file is readable and writable by the read/write latency prediction model training module according to claim 4 and read-only for another module in the system.

Module M3.2.2 is specifically a latency prediction model training and update module.

When receiving a read/write task record from the read/write latency record persistence and summarization module according to claim 5, the latency prediction model training and update module performs a latency prediction model training and update operation.

The latency prediction model training and update module uses the input read/write task record and a corresponding real-time latency result as input and output training data for the neural network model, respectively, and trains the latency prediction model using a gradient descent method until an error between a latency prediction result of the model and actual latency data converges.

When the error acquired from model convergence is less than an average error at the start of training, the latency prediction model training and update module performs a model update to persistently store the trained model as a new storage file and overwrite an original model storage file

Preferably, components of the module M3.3 are described as follows.

Module M3.3.1 is specifically a real-time device read/write pressure collection module.

When the real-time read/write task latency prediction module according to claim 4 receives a real-time read/write latency prediction request, the real-time device read/write pressure collection module acquires summary information of a read/write task currently being executed in the read/write task execution module of the system and sends the information as part of a parameter to the neural network-based read/write latency prediction model according to claim 6.

Module M3.3.2 is specifically a real-time read/write task latency prediction module.

When the real-time device read/write pressure collection module completes the collection and sending operation, the real-time read/write task latency prediction module invokes the neural network-based prediction model to perform real-time read/write latency prediction.

When the real-time read/write latency prediction is completed, the read/write task latency prediction module submits a prediction result to the read/write task execution module according to claim 1.

Preferably, components of the module M4 are described as follows.

Module M4.1 is specifically an RDMA-based remote data read/write thread pool module.

When the high-concurrency read/write optimization system for a distributed file system according to claim 1 is constructed, the RDMA-based remote data read/write thread pool module initializes a certain number of RDMA connections and completes an information exchange test between the client system and the server file system.

When an RDMA connection is established, the RDMA-based remote data read/write thread pool module creates an RDMA primitive-based remote data read/write thread pool and sets all threads to an idle state.

When a new remote read/write task is submitted to the read/write task execution module according to claim 1, the RDMA-based remote data read/write thread pool module schedules an idle thread to execute the task.

Module M4.2 is specifically a NVM-based cache data read/write thread pool module.

When the high-concurrency read/write optimization system for a distributed file system according to claim 1 is constructed, the NVM-based cache data read/write thread pool module completes a read/write operation test of the client system on a local NVM.

When the read/write operation test on the NVM is completed, the NVM-based cache data read/write thread pool module creates a load/store primitive-based NVM data read/write thread pool and sets all threads to an idle state.

When a new local read/write task is submitted to the read/write task execution module according to claim 1, the NVM-based cache data read/write thread pool module schedules an idle thread to execute the task.

The present disclosure further provides a computer-readable storage medium for storing a computer program. The computer program is executed by a processor to implement functions of the modules described above.

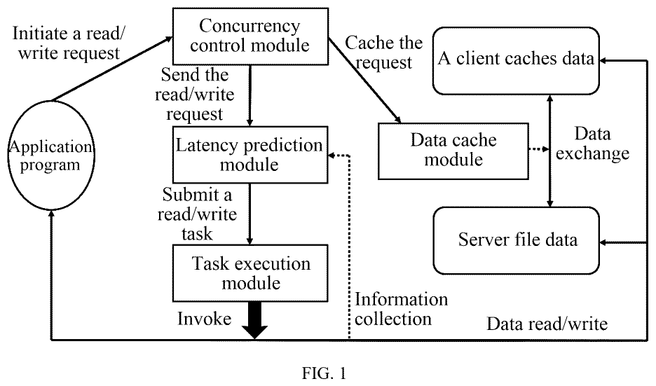

As shown in FIG. 1, the high-concurrency read/write optimization system for a distributed file system provided by the present disclosure includes: a data read/write concurrency control module, a file data cache module, a read/write request latency prediction module, and a read/write task execution module.

The data read/write concurrency control module constructs a fine-grained read/write lock at a file system server to ensure consistency and high concurrency of data, and constructs a client data permission lease record table based on a hash table at a file system client to reduce a time overhead caused by concurrent lock requests.

The file data cache module is configured to control data caching of a server file system by a client system.

The read/write request latency prediction module constructs a read/write task latency prediction model based on a neural network structure and predicts a real-time file read/write request latency in the file system client.

The read/write task execution module establishes two read/write task thread pools to schedule local and remote read/write tasks while executing local and remote data read/write operations to enhance read/write performance under a concurrent condition.

When a file system client application initiates a file read/write request, the request is first submitted to the concurrency control module. After parsing the read/write request, this module submits a data cache request to the data caching module while sending the read/write task description to the latency prediction module to acquire a read/write latency prediction result.

When both the data cache operation and the read/write latency prediction are completed, the read/write task is submitted by the latency prediction module to the task execution module, and concurrently executed by the read/write thread pools in the task execution module.

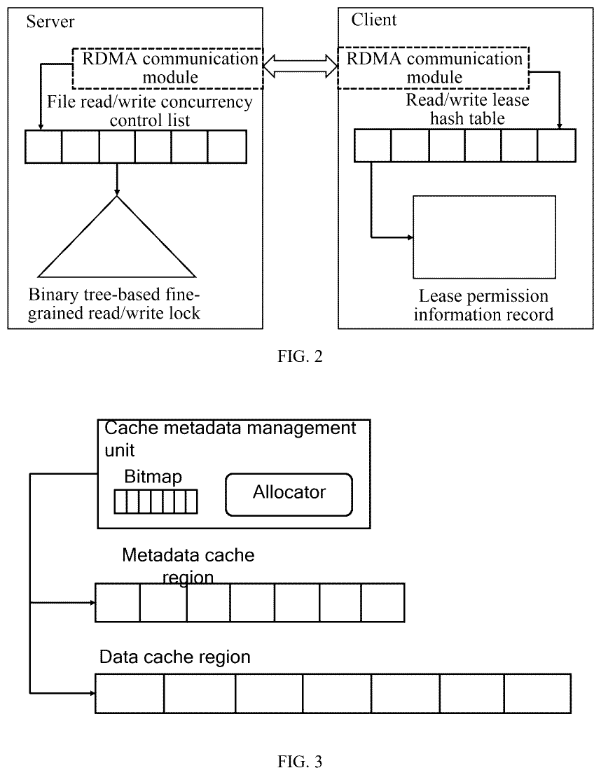

As shown in FIG. 2, the data read/write concurrency control module of the present disclosure includes: a binary tree-based fine-grained file data read/write lock module and a hash table-based client data permission lease module.

The binary tree-based fine-grained file data read/write lock module includes a binary tree list; each binary tree in the list corresponds to a file data read/write lock management unit in an open state. The binary tree list uses a unique identifier of the file in the distributed file system as an index.

Each binary tree includes a data interval occupied by a read/write request for a current file. The interval is represented by a tuple including a start offset and a length of the read/write request. A root node of the binary tree corresponds to an interval of all data in the file, and each child node corresponds to a data interval acquired by bisecting a parent node interval. A corresponding data segment of each node includes a read/write lock, allowing a requester to simultaneously acquire one-write-multiple-read permissions.

When a new read/write request is submitted to a file server, a data read/write lock binary tree corresponding to a file number is indexed, and a read/write permission record on a corresponding node is searched for, added, or modified. When a read/write permission is reclaimed, the read/write permission on the corresponding node is modified or deleted.

The hash table-based client data permission lease module includes a hash table including a lease record, where the harsh table maintains all read/write lease permissions currently retained by the client system.

When a client application initiates a file read/write request, the read/write request is submitted to a file system server while a data caching request is submitted to the file data cache module of the present disclosure.

When processing of a read/write permission request and the caching request is completed, a read/write descriptor is added to the hash table while the read/write request to be executed is sent to the read/write latency prediction module of the present disclosure.

In the distributed file system, the file data read/write lock module and the data permission lease module send information via an RDMA communication unit between the client and the server.

As shown in FIG. 3, the file data cache module of the present disclosure includes:

a metadata cache unit, a file data cache unit, and a metadata management unit for the local data cache.

The metadata cache unit caches metadata information in the file system inode, providing caching services for metadata-related operations of the client to reduce time overhead.

The file data cache unit caches only the actual data in file data blocks, providing caching services for data read/write-related operations of the client to reduce time overhead. This unit also utilizes the modified, exclusive, shared, invalid (MESI) cache coherence protocol.

The metadata management unit of the local data cache manages space allocation for the local cache region, allocates the NVM When a new cache space is needed, and consolidates cache content or replaces outdated cache data blocks and metadata blocks when the cache region is full.

When the client system initiates a metadata operation-related request, the metadata cache unit requests a metadata permission from the file system server and caches a relevant metadata region locally on the client.

When the client system initiates a data read/write-related request, the data cache unit reads or writes back data from/to the file system server. Simultaneously, the metadata management unit for the local data cache modifies metadata information in a local cache region. The design ensures the consistency and correctness of the data cache region.

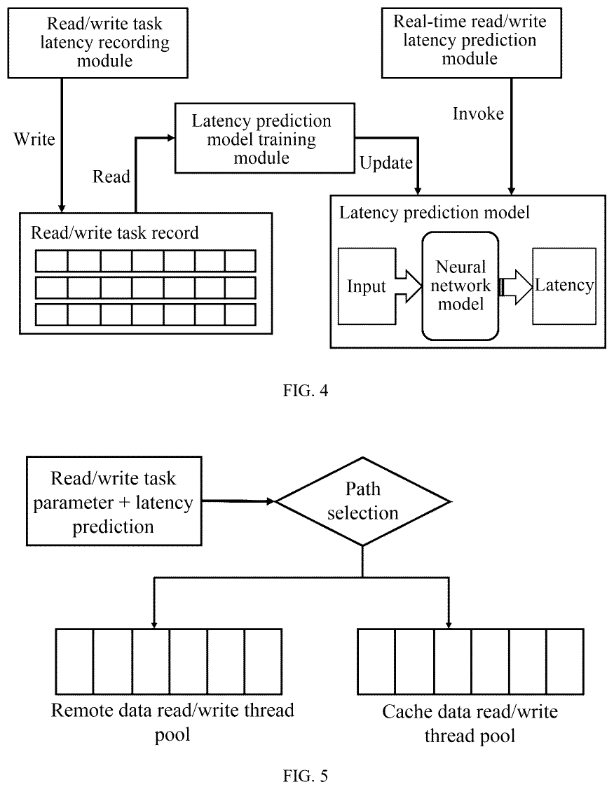

As shown in FIG. 4, the read/write latency prediction module provided according to the present disclosure includes three sub-modules: a data read/write task latency recording module, a read/write latency prediction model training module, and a real-time read/write task latency prediction module.

The data read/write task latency recording module further includes two sub-modules: a file system read/write operation tracking module and a read/write latency record persistence and summarization module.

During system operation, the file system read/write operation tracking module performs the following operations.

When the read/write task execution module of the present disclosure executes a remote or local read/write task, the file system read/write operation tracking module records a parameter of the read/write task, including a read/write file identifier, a read/write flag, a remote/local flag, a read/write offset, and a read/write length, and simultaneously records a start time of the read/write task.

When the read/write task execution module of the present disclosure completes the remote or local read/write task, the file system read/write operation tracking module records an end time of the read/write task.

During system operation, the read/write latency record persistence and summarization module executes following operations.

When the file system read/write operation tracking module completes a task record, the read/write latency record persistence and summarization module writes the record to a persistent local file. The file is opened in append mode. each time when new content is appended, the new content is sequentially written to the file.

When a record length of the persistent local file exceeds a threshold, the newly appended content in the file is submitted to the read/write latency prediction model training module.

When data recorded in the persistent local file has been processed by the read/write latency prediction model training module, the read/write latency record persistence and summarization module truncates old data recorded in the local file, ensuring that a record file size does not exceed the threshold. The setting of this threshold ensures that the storage space occupied by the read/write latency prediction model in the file system is controllable, while not affecting the storage of the latest data to support model training.

Additionally, the read/write latency prediction model training module includes two sub-modules: a read/write latency prediction model construction module and a latency prediction model training and update module.

When the distributed file system is initialized, the read/write latency prediction model construction module executes a task of constructing a neural network-based read/write latency prediction model.

The neural network-based read/write latency prediction model includes a double-layer fully connected neural network. The neural network takes the descriptive parameter of the read/write task as input data and outputs a real-time latency prediction result for the read/write task, in a real-world standard time unit, for example, microsecond.

Before construction of the read/write latency prediction model is completed, neural network model parameters of the prediction model are subjected to two initialization schemes. in a first scheme, the model parameters all are initialized to zero values. In a second scheme, the model parameters are initialized to parameters of a latency prediction model trained in another system.

When construction of the read/write latency prediction model is completed, the model is persistently stored as a file. The file is readable and writable by the read/write latency prediction model training module and read-only for another module in the system of the present disclosure.

During system operation, when receiving a read/write task record from the read/write latency record persistence and summarization module, the latency prediction model training and update module performs a latency prediction model training and update operation.

The training data is delivered to the latency prediction model training and update module in batches. The batch size of the training data is set to a power of 2, for example: 2,048 task records, to optimize the memory overhead of the neural network.

At the start of training, the latency prediction model training and update module uses the input read/write task record and a corresponding real-time latency result as input and output training data for the neural network model, respectively, and trains the latency prediction model using a gradient descent method until an error between a latency prediction result of the model and actual latency data converges. That is, within one training epoch, the training error no longer exhibits a decrease of more than 1%.

When the error acquired from model convergence is less than an average error at the start of training, the latency prediction model training and update module performs a model update to persistently store the trained model as a new storage file and overwrite an original model storage file.

Additionally, the real-time read/write task latency prediction module includes two sub-modules: a real-time device read/write pressure collection module and a real-time read/write task latency prediction module.

During system operation, when the real-time read/write task latency prediction module receives a real-time read/write latency prediction request, the first sub-module, namely the real-time device read/write pressure collection module acquires summary information of a read/write task currently being executed in the read/write task execution module of the system and sends the information as part of a parameter to the neural network-based read/write latency prediction model to assist in real-time latency prediction.

During system operation, when the real-time device read/write pressure collection module completes the collection and sending operation, the real-time read/write task latency prediction module invokes the neural network-based prediction model to perform real-time read/write latency prediction.

When the real-time read/write latency prediction is completed, the read/write task latency prediction module submits a prediction result to the read/write task execution module, providing assistance for the module in selecting a proper read/write task thread pool and completing efficient data read/write operations.

As shown in FIG. 5, the read/write task execution module provided according to the present disclosure includes two sub-modules: an RDMA-based remote data read/write thread pool module and a NVM-based cache data read/write thread pool module.

The RDMA-based remote data read/write thread pool module is responsible for scheduling and executing remote read/write tasks assigned to the server of the distributed file system.

When the high-concurrency read/write optimization system for a distributed file system in the present disclosure is constructed, the RDMA-based remote data read/write thread pool module initializes a certain number of RDMA connections and completes an information exchange test from the client system to the server file system, including a send/recv operation test and a read/write test.

When an RDMA connection is established, the RDMA-based remote data read/write thread pool module creates an RDMA primitive-based remote data read/write thread pool and sets all threads to an idle state.

When a new remote read/write task is submitted to the read/write task execution module, the RDMA-based remote data read/write thread pool module schedules an idle thread to execute the task.

The NVM-based cache data read/write thread pool module is responsible for scheduling and executing read/write tasks assigned to the local NVM cache region.

When the high-concurrency read/write optimization system for a distributed file system according to the present disclosure is constructed, the NVM-based cache data read/write thread pool module completes a read/write operation test of the client system on a local NVM, including a read/write operation test using load/store on the NVM.

When the read/write operation test on the NVM is completed, the NVM-based cache data read/write thread pool module creates a memory primitive-based NVM data read/write thread pool and sets all threads to an idle state. When a new local read/write task is submitted to the read/write task execution module, the NVM-based cache data read/write thread pool module schedules an idle thread to execute the task.

Those skilled in the art may understand this embodiment as a more specific elaboration of Embodiment 1.

Those skilled in the art are aware that in addition to being realized by using pure computer-readable program code, the system and each apparatus, module, and unit thereof provided in the present disclosure can realize a same function in a form of a logic gate, a switch, an application-specific integrated circuit, a programmable logic controller, or an embedded microcontroller by performing logic programming on the method steps. Therefore, the system and each apparatus, module, and unit thereof provided in the present disclosure can be regarded as a kind of hardware component. The apparatus, module, and unit included therein for realizing each function can also be regarded as a structure in the hardware component. The apparatus, module, and unit for realizing each function can also be regarded as a software module for implementing the method or a structure in the hardware component.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments of the present disclosure and features in the embodiments may be arbitrarily combined with each other in a non-conflicting situation.

What is claimed is:

1. A high-concurrency read/write optimization system for a distributed file system, comprising following modules:
a module M1, specifically, a data read/write concurrency control module, configured to acquire consistent and highly concurrent data through a fine-grained read/write lock;
a module M2, specifically, a file data cache module, configured to control data caching of a server file system by a client system;
a module M3, specifically, a read/write request latency prediction module, configured to predict a runtime latency of a file read/write request in a file system client; and
a module M4, specifically, a read/write task execution module, configured to acquire read/write performance under a concurrent condition by simultaneously executing local and remote data read/write operations;
wherein the data read/write concurrency control module processes multi-thread concurrent file data read/write requests from multiple clients and acquires consistent file data and concurrent read/write requests;
the file data cache module constructs a file data cache in the client system, such that a recent read/write request to a file by an application is stored in a local data cache;
the read/write request latency prediction module records a latency of a data read/write task in the system and predicts a runtime read/write request latency through a prediction model; and
the read/write task execution module maintains two thread pools, executes a data read/write task on a remote server and a data read/write task on a local cache, respectively, and acquires the read/write performance under the concurrent condition.

2. The high-concurrency read/write optimization system for the distributed file system according to claim 1, wherein the module M1 comprises:
a module M1.1, specifically, a binary tree-based fine-grained file data read/write lock module; and
a module M1.2, specifically, a hash table-based client data permission lease module;
wherein the binary tree-based fine-grained file data read/write lock module comprises a binary tree list; each binary tree in the list corresponds to a file data read/write lock management unit in an open state; and the binary tree list uses a unique identifier of the file in the distributed file system as an index;
each binary tree comprises a data interval occupied by a read/write request for a current file; the interval is represented by a tuple comprising a start offset and a length of the read/write request; a root node of the binary tree corresponds to an interval of all data in the file, and each child node corresponds to a data interval acquired by bisecting a parent node interval; and a corresponding data segment of each node comprises a read/write lock, allowing a requester to simultaneously acquire one-write-multiple-read permissions;
when a new read/write request is submitted to a file server, a data read/write lock binary tree corresponding to a file number is indexed, and a read/write permission record on a corresponding node is searched for, added, or modified; and when a read/write permission is reclaimed, the read/write permission on the corresponding node is modified or deleted;
the hash table-based client data permission lease module comprises a hash table comprising a lease record, wherein the harsh table maintains all read/write lease permissions currently retained by the client system;
when a client application initiates a file read/write request, the read/write request is submitted to a file system server while a data caching request is submitted to the module M2; and
when processing of a read/write permission request and the caching request is completed, a read/write descriptor is added to the hash table while the read/write request to be executed is sent to the module M3.

3. The high-concurrency read/write optimization system for the distributed file system according to claim 1, wherein the module M2 comprises:
a data cache management module running in the client system of the distributed file system;
wherein the data cache management module comprises a metadata cache unit, a data cache unit, and a metadata management unit for the local data cache;
when the client system initiates a metadata operation-related request, the metadata cache unit requests a metadata permission from a file system server and caches a relevant metadata region locally on the client; and
when the client system initiates a data read/write-related request, the data cache unit reads or writes back data from/to the file system server; and simultaneously, the metadata management unit for the local data cache modifies metadata information in a local cache region.

4. The high-concurrency read/write optimization system for the distributed file system according to claim 1, wherein the module M3 comprises:
a module M3.1, specifically, a data read/write task latency recording module;
a module M3.2, specifically, a read/write latency prediction model training module; and
a module M3.3, specifically, a real-time read/write task latency prediction module;
wherein when the module M4 executes a read/write task, the read/write task latency recording module is awakened and tracks a descriptive parameter and start/end time of the read/write task; and simultaneously, the module sequentially records a data structure comprising the descriptive parameter and start/end time of each read/write task into persistent file storage;
when a size change of a read/write task latency record file output by the module M3.1 exceeds a certain threshold, the read/write latency prediction model training module reads a newly added task latency record in the file, and converts the newly added task latency record into empirical knowledge for the prediction model through a model training method; and
when receiving a read/write task sent by the module M1, the real-time read/write task latency prediction module inputs the received real-time read/write task into a trained latency prediction model, predicts a latency of executing the read/write task via a remote server node and a latency of executing the read/write task via the local cache and bypassing the remote node, respectively, and compares the two latencies to acquire an option for a read/write path scheme.

5. The high-concurrency read/write optimization system for the distributed file system according to claim 4, wherein the module M3.1 comprises:
a module M3.1.1, specifically, a file system read/write operation tracking module; and
a module M3.1.2, specifically, a read/write latency record persistence and summarization module;
wherein when the module M4 executes a remote or local read/write task, the file system read/write operation tracking module records a parameter of the read/write task, comprising a read/write file identifier, a read/write flag, a remote/local flag, a read/write offset, and a read/write length, and simultaneously records a start time of the read/write task;
when the module M4 completes the remote or local read/write task, the file system read/write operation tracking module records an end time of the read/write task;
when the file system read/write operation tracking module completes a task record, the read/write latency record persistence and summarization module writes the record to a persistent local file; the file is opened in append mode; and each time when new content is appended, the new content is sequentially written to the file;
when a record length of the persistent local file exceeds a threshold, the newly appended content in the file is submitted to the read/write latency prediction model training module; and
when data recorded in the persistent local file has been processed by the read/write latency prediction model training module, the read/write latency record persistence and summarization module truncates old data recorded in the persistent local file, ensuring that a record file size does not exceed the threshold.

6. The high-concurrency read/write optimization system for the distributed file system according to claim 4, wherein the module M3.2 comprises:
a module M3.2.1, specifically, a read/write latency prediction model construction module; and
a module M3.2.2, specifically, a latency prediction model training and update module;
wherein when the high-concurrency read/write optimization system for the distributed file system is constructed, the read/write latency prediction model construction module constructs a neural network-based read/write latency prediction model;
the neural network-based read/write latency prediction model comprises a double-layer fully connected neural network; the neural network takes the descriptive parameter of the read/write task as input data and outputs a real-time latency prediction result for the read/write task, in a real-world standard time unit;
before construction of the read/write latency prediction model is completed, neural network model parameters of the prediction model are subjected to two initialization schemes; in a first scheme, the model parameters all are initialized to zero values; and in a second scheme, the model parameters are initialized to parameters of a latency prediction model trained in another system;
when construction of the read/write latency prediction model is completed, the model is persistently stored as a file; and the file is readable and writable by the read/write latency prediction model training module and read-only for another module in the system;
when receiving a read/write task record from the read/write latency record persistence and summarization module, the latency prediction model training and update module performs a latency prediction model training and update operation;
the latency prediction model training and update module uses the input read/write task record and a corresponding real-time latency result as input and output training data for the neural network model, respectively, and trains the latency prediction model using a gradient descent method until an error between a latency prediction result of the model and actual latency data converges; and
when the error acquired from model convergence is less than an average error at the start of training, the latency prediction model training and update module performs a model update to persistently store the trained model as a new storage file and overwrite an original model storage file

7. The high-concurrency read/write optimization system for the distributed file system according to claim 4, wherein the module M3.3 comprises:
a module M3.3.1, specifically, a real-time device read/write pressure collection module; and
a module M3.3.2, specifically, a real-time read/write task latency prediction module;
wherein when the real-time read/write task latency prediction module receives a real-time read/write latency prediction request, the real-time device read/write pressure collection module acquires summary information of a read/write task currently being executed in the read/write task execution module of the system and sends the information as part of a parameter to a neural network-based read/write latency prediction model;
when the real-time device read/write pressure collection module completes the collection and sending operation, the real-time read/write task latency prediction module invokes the neural network-based read/write latency prediction model to perform real-time read/write latency prediction; and
when the real-time read/write latency prediction is completed, the read/write task latency prediction module submits a prediction result to the read/write task execution module.

8. The high-concurrency read/write optimization system for the distributed file system according to claim 1, wherein the module M4 comprises:
a module M4.1, specifically, a remote direct memory access (RDMA)-based remote data read/write thread pool module; and
a module M4.2, specifically, a non-volatile memory (NVM)-based cache data read/write thread pool module;
wherein when the high-concurrency read/write optimization system for the distributed file system is constructed, the RDMA-based remote data read/write thread pool module initializes a certain number of RDMA connections and completes an information exchange test between the client system and the server file system;
when an RDMA connection is established, the RDMA-based remote data read/write thread pool module creates an RDMA primitive-based remote data read/write thread pool and sets all threads to an idle state;
when a new remote read/write task is submitted to the read/write task execution module, the RDMA-based remote data read/write thread pool module schedules an idle thread to execute the task;
when the high-concurrency read/write optimization system for the distributed file system is constructed, the NVM-based cache data read/write thread pool module completes a read/write operation test of the client system on a local NVM;
when the read/write operation test on the NVM is completed, the NVM-based cache data read/write thread pool module creates a load/store primitive-based NVM data read/write thread pool and sets all threads to an idle state; and
when a new local read/write task is submitted to the read/write task execution module, the NVM-based cache data read/write thread pool module schedules an idle thread to execute the task.

9. A computer-readable storage medium for storing a computer program, wherein the computer program is executed by a processor to implement functions of the modules according to claim 1.

10. An electronic device, comprising: a memory, a processor, and a computer program stored on the memory and runnable on the processor, wherein the computer program is executed by the processor to implement functions of the modules according to claim 1.

11. The computer-readable storage medium according to claim 9, wherein the module M1 comprises:
a module M1.1, specifically, a binary tree-based fine-grained file data read/write lock module; and
a module M1.2, specifically, a hash table-based client data permission lease module;
wherein the binary tree-based fine-grained file data read/write lock module comprises a binary tree list; each binary tree in the list corresponds to a file data read/write lock management unit in an open state; and the binary tree list uses a unique identifier of the file in the distributed file system as an index;
each binary tree comprises a data interval occupied by a read/write request for a current file; the interval is represented by a tuple comprising a start offset and a length of the read/write request; a root node of the binary tree corresponds to an interval of all data in the file, and each child node corresponds to a data interval acquired by bisecting a parent node interval; and a corresponding data segment of each node comprises a read/write lock, allowing a requester to simultaneously acquire one-write-multiple-read permissions;
when a new read/write request is submitted to a file server, a data read/write lock binary tree corresponding to a file number is indexed, and a read/write permission record on a corresponding node is searched for, added, or modified; and when a read/write permission is reclaimed, the read/write permission on the corresponding node is modified or deleted;
the hash table-based client data permission lease module comprises a hash table comprising a lease record, wherein the harsh table maintains all read/write lease permissions currently retained by the client system;
when a client application initiates a file read/write request, the read/write request is submitted to a file system server while a data caching request is submitted to the module M2; and
when processing of a read/write permission request and the caching request is completed, a read/write descriptor is added to the hash table while the read/write request to be executed is sent to the module M3.

12. The computer-readable storage medium according to claim 9, wherein the module M2 comprises:
a data cache management module running in the client system of the distributed file system;
wherein the data cache management module comprises a metadata cache unit, a data cache unit, and a metadata management unit for the local data cache;
when the client system initiates a metadata operation-related request, the metadata cache unit requests a metadata permission from a file system server and caches a relevant metadata region locally on the client; and
when the client system initiates a data read/write-related request, the data cache unit reads or writes back data from/to the file system server; and simultaneously, the metadata management unit for the local data cache modifies metadata information in a local cache region.

13. The computer-readable storage medium according to claim 9, wherein the module M3 comprises:
a module M3.1, specifically, a data read/write task latency recording module;
a module M3.2, specifically, a read/write latency prediction model training module; and
a module M3.3, specifically, a real-time read/write task latency prediction module;
wherein when the module M4 executes a read/write task, the read/write task latency recording module is awakened and tracks a descriptive parameter and start/end time of the read/write task; and simultaneously, the module sequentially records a data structure comprising the descriptive parameter and start/end time of each read/write task into persistent file storage;
when a size change of a read/write task latency record file output by the module M3.1 exceeds a certain threshold, the read/write latency prediction model training module reads a newly added task latency record in the file, and converts the newly added task latency record into empirical knowledge for the prediction model through a model training method; and
when receiving a read/write task sent by the module M1, the real-time read/write task latency prediction module inputs the received real-time read/write task into a trained latency prediction model, predicts a latency of executing the read/write task via a remote server node and a latency of executing the read/write task via the local cache and bypassing the remote node, respectively, and compares the two latencies to acquire an option for a read/write path scheme.

14. The computer-readable storage medium according to claim 13, wherein the module M3.1 comprises:
a module M3.1.1, specifically, a file system read/write operation tracking module; and
a module M3.1.2, specifically, a read/write latency record persistence and summarization module;
wherein when the module M4 executes a remote or local read/write task, the file system read/write operation tracking module records a parameter of the read/write task, comprising a read/write file identifier, a read/write flag, a remote/local flag, a read/write offset, and a read/write length, and simultaneously records a start time of the read/write task;
when the module M4 completes the remote or local read/write task, the file system read/write operation tracking module records an end time of the read/write task;
when the file system read/write operation tracking module completes a task record, the read/write latency record persistence and summarization module writes the record to a persistent local file; the file is opened in append mode; and each time when new content is appended, the new content is sequentially written to the file;
when a record length of the persistent local file exceeds a threshold, the newly appended content in the file is submitted to the read/write latency prediction model training module; and
when data recorded in the persistent local file has been processed by the read/write latency prediction model training module, the read/write latency record persistence and summarization module truncates old data recorded in the persistent local file, ensuring that a record file size does not exceed the threshold.

15. The computer-readable storage medium according to claim 13, wherein the module M3.2 comprises:
a module M3.2.1, specifically, a read/write latency prediction model construction module; and
a module M3.2.2, specifically, a latency prediction model training and update module;
wherein when the high-concurrency read/write optimization system for the distributed file system is constructed, the read/write latency prediction model construction module constructs a neural network-based read/write latency prediction model;
the neural network-based read/write latency prediction model comprises a double-layer fully connected neural network; the neural network takes the descriptive parameter of the read/write task as input data and outputs a real-time latency prediction result for the read/write task, in a real-world standard time unit;
before construction of the read/write latency prediction model is completed, neural network model parameters of the prediction model are subjected to two initialization schemes; in a first scheme, the model parameters all are initialized to zero values; and in a second scheme, the model parameters are initialized to parameters of a latency prediction model trained in another system;
when construction of the read/write latency prediction model is completed, the model is persistently stored as a file; and the file is readable and writable by the read/write latency prediction model training module and read-only for another module in the system;
when receiving a read/write task record from the read/write latency record persistence and summarization module, the latency prediction model training and update module performs a latency prediction model training and update operation;
the latency prediction model training and update module uses the input read/write task record and a corresponding real-time latency result as input and output training data for the neural network model, respectively, and trains the latency prediction model using a gradient descent method until an error between a latency prediction result of the model and actual latency data converges; and
when the error acquired from model convergence is less than an average error at the start of training, the latency prediction model training and update module performs a model update to persistently store the trained model as a new storage file and overwrite an original model storage file.

16. The computer-readable storage medium according to claim 13, wherein the module M3.3 comprises:
a module M3.3.1, specifically, a real-time device read/write pressure collection module; and
a module M3.3.2, specifically, a real-time read/write task latency prediction module;
wherein when the real-time read/write task latency prediction module receives a real-time read/write latency prediction request, the real-time device read/write pressure collection module acquires summary information of a read/write task currently being executed in the read/write task execution module of the system and sends the information as part of a parameter to a neural network-based read/write latency prediction model;
when the real-time device read/write pressure collection module completes the collection and sending operation, the real-time read/write task latency prediction module invokes the neural network-based read/write latency prediction model to perform real-time read/write latency prediction; and
when the real-time read/write latency prediction is completed, the read/write task latency prediction module submits a prediction result to the read/write task execution module.

17. The computer-readable storage medium according to claim 9, wherein the module M4 comprises:
a module M4.1, specifically, a remote direct memory access (RDMA)-based remote data read/write thread pool module; and
a module M4.2, specifically, a non-volatile memory (NVM)-based cache data read/write thread pool module;
wherein when the high-concurrency read/write optimization system for the distributed file system is constructed, the RDMA-based remote data read/write thread pool module initializes a certain number of RDMA connections and completes an information exchange test between the client system and the server file system;
when an RDMA connection is established, the RDMA-based remote data read/write thread pool module creates an RDMA primitive-based remote data read/write thread pool and sets all threads to an idle state;
when a new remote read/write task is submitted to the read/write task execution module, the RDMA-based remote data read/write thread pool module schedules an idle thread to execute the task;
when the high-concurrency read/write optimization system for the distributed file system is constructed, the NVM-based cache data read/write thread pool module completes a read/write operation test of the client system on a local NVM;
when the read/write operation test on the NVM is completed, the NVM-based cache data read/write thread pool module creates a load/store primitive-based NVM data read/write thread pool and sets all threads to an idle state; and
when a new local read/write task is submitted to the read/write task execution module, the NVM-based cache data read/write thread pool module schedules an idle thread to execute the task.

18. The electronic device according to claim 10, wherein the module M1 comprises:
a module M1.1, specifically, a binary tree-based fine-grained file data read/write lock module; and
a module M1.2, specifically, a hash table-based client data permission lease module;
wherein the binary tree-based fine-grained file data read/write lock module comprises a binary tree list; each binary tree in the list corresponds to a file data read/write lock management unit in an open state; and the binary tree list uses a unique identifier of the file in the distributed file system as an index;
each binary tree comprises a data interval occupied by a read/write request for a current file; the interval is represented by a tuple comprising a start offset and a length of the read/write request; a root node of the binary tree corresponds to an interval of all data in the file, and each child node corresponds to a data interval acquired by bisecting a parent node interval; and a corresponding data segment of each node comprises a read/write lock, allowing a requester to simultaneously acquire one-write-multiple-read permissions;
when a new read/write request is submitted to a file server, a data read/write lock binary tree corresponding to a file number is indexed, and a read/write permission record on a corresponding node is searched for, added, or modified; and when a read/write permission is reclaimed, the read/write permission on the corresponding node is modified or deleted;
the hash table-based client data permission lease module comprises a hash table comprising a lease record, wherein the harsh table maintains all read/write lease permissions currently retained by the client system;
when a client application initiates a file read/write request, the read/write request is submitted to a file system server while a data caching request is submitted to the module M2; and
when processing of a read/write permission request and the caching request is completed, a read/write descriptor is added to the hash table while the read/write request to be executed is sent to the module M3.

19. The electronic device according to claim 10, wherein the module M2 comprises:
a data cache management module running in the client system of the distributed file system;
wherein the data cache management module comprises a metadata cache unit, a data cache unit, and a metadata management unit for the local data cache;
when the client system initiates a metadata operation-related request, the metadata cache unit requests a metadata permission from a file system server and caches a relevant metadata region locally on the client; and
when the client system initiates a data read/write-related request, the data cache unit reads or writes back data from/to the file system server; and simultaneously, the metadata management unit for the local data cache modifies metadata information in a local cache region.

20. The electronic device according to claim 10, wherein the module M3 comprises:
a module M3.1, specifically, a data read/write task latency recording module;
a module M3.2, specifically, a read/write latency prediction model training module; and
a module M3.3, specifically, a real-time read/write task latency prediction module;
wherein when the module M4 executes a read/write task, the read/write task latency recording module is awakened and tracks a descriptive parameter and start/end time of the read/write task; and simultaneously, the module sequentially records a data structure comprising the descriptive parameter and start/end time of each read/write task into persistent file storage;
when a size change of a read/write task latency record file output by the module M3.1 exceeds a certain threshold, the read/write latency prediction model training module reads a newly added task latency record in the file, and converts the newly added task latency record into empirical knowledge for the prediction model through a model training method; and
when receiving a read/write task sent by the module M1, the real-time read/write task latency prediction module inputs the received real-time read/write task into a trained latency prediction model, predicts a latency of executing the read/write task via a remote server node and a latency of executing the read/write task via the local cache and bypassing the remote node, respectively, and compares the two latencies to acquire an option for a read/write path scheme.
